(19) United States
(12) Patent Application Publication
(10) Pub. No.: US 2020/0159299 A1
(43) Pub. Date: May 21, 2020

(54) POWER SUPPLY AND ELECTRONIC DEVICE INCLUDING THE SAME

(71) Applicant: Cheng Uei Precision Industry Co., Ltd., New Taipei City (TW)

(72) Inventor: JUNG-CHING CHENG, New Taipei City (TW)

(21) Appl. No.: 16/445,168

(22) Filed: Jun. 18, 2019

(30) Foreign Application Priority Data
Nov. 19, 2018 (CN) 201821900856.4

(51) Int. Cl. G06F 1/26; F21V 23/02; H02J 7/00

(52) U.S. Cl. CPC G06F 1/263; F21V 23/023; H02J 7/0045; H02J 7/0009; H02J 7/0065

(57) ABSTRACT

A power supply includes a base body, at least one battery, at least one magnetic component, a conductive element, and a conductive connector electrically connected with the at least one battery. The base body includes a hollow outer shell. The outer shell has an accommodating space. The at least one battery is accommodated in the accommodating space. A top of the outer shell has a first buckling surface. A bottom of the outer shell has a second buckling surface. The at least one magnetic component is disposed to the outer shell. The first buckling surface and the second buckling surface of at least two power supplies cooperate to be fastened. The conductive element is disposed to the first buckling surface and electrically connected with the at least one battery. The conductive connector is disposed to the second buckling surface. The conductive connector is electrically connected with the conductive element.

### CROSS-REFERENCE TO RELATED APPLICATION

The present application is based on, and claims priority form, China Patent Application No. 201821900856.4, filed Nov. 19, 2018, the disclosure of which is hereby incorporated by reference herein in its entirety.

### BACKGROUND OF THE INVENTION

### 1. Field of the Invention

The present invention generally relates to a power supply, and more particularly to a power supply capable of being expanded to different electronic devices with multiple functions, each of which is capable of including at least two power supplies combined together to have a durable battery life.

### 2. The Related Art

With the growth of mobile entertainment requirements and other various requirements, electronic products carried by people are more and more. Because primary batteries of the electronic products have lower capacities, the primary batteries of the electronic products are incapable of satisfying normal usage time of the electronic products. Based on the above-mentioned problem, in order to solve a power consumption problem of each electronic product, a current power supply is provided for satisfying the people to charge the electronic products whenever and wherever.

Due to a battery life requirement of the power supply being gradually required higher, that functional diversities are pursued has become a purpose which every enterprise is anxious to achieve.

However, the current power supplies on sale have following drawbacks: firstly, the electronic products are just charged by transmission cables, secondly, electric capacities of the power supplies are limited and are incapable of being expanded, thirdly, the power supply is incapable of being expanded to different devices with multiple functions, such as a solar charger, a storage box, a blue tooth loudspeaker, and other devices with different functions. As a result, the current power supply is without satisfying requirements of different users.

### SUMMARY OF THE INVENTION

An object of the present invention is to provide a power supply. The power supply includes a base body, at least one battery, at least one magnetic component, a conductive element, and a conductive connector electrically connected with the at least one battery. The base body includes a hollow outer shell. A middle of the outer shell has an accommodating space inside the outer shell. The at least one battery is accommodated in the accommodating space. A top of the outer shell has a first buckling surface recessed towards the inside of the outer shell. A bottom of the outer shell has a second buckling surface protruded outward away from the inside of the outer shell and opposite to the first buckling surface. The at least one magnetic component is disposed to the outer shell of the base body. The first buckling surface and the second buckling surface of at least two power supplies cooperate to be combined and fastened by virtue of at least two magnetic components of the at least two power supplies magnetically attracting. The conductive element is of a dual-concentric-ring shape. The conductive element is disposed to and exposed to the first buckling surface, and the conductive element is electrically connected with the at least one battery. The conductive connector is disposed to the second buckling surface, and a bottom of the conductive connector is exposed to the second buckling surface. The bottom of the conductive connector cooperates with and is electrically connected with the conductive element to make the at least two power supplies be electrically connected, so an electric capacity of the at least two power supplies is increased.

Another object of the present invention is to provide an electronic device. The electronic device includes at least two power supplies. Each power supply includes a base body, at least one battery, at least one magnetic component, a conductive element, and a conductive connector electrically connected with the at least one battery. The base body includes a hollow outer shell. A middle of the outer shell has an accommodating space inside the outer shell. The at least one battery is accommodated in the accommodating space. A top of the outer shell has a first buckling surface recessed towards the inside of the outer shell. A bottom of the outer shell has a second buckling surface protruded outward away from the inside of the outer shell and opposite to the first buckling surface. The at least one magnetic component is disposed to the outer shell of the base body. The first buckling surface and the second buckling surface of the at least two power supplies cooperate to be combined and fastened by virtue of at least two magnetic components of the at least two power supplies magnetically attracting. The conductive element is of a dual-concentric-ring shape. The conductive element is disposed to and exposed to the first buckling surface, and the conductive element is electrically connected with the at least one battery. The conductive connector is disposed to the second buckling surface, and a bottom of the conductive connector is exposed to the second buckling surface. The bottom of the conductive connector cooperates with and is electrically connected with the conductive element to make the at least two power supplies be electrically connected, so an electric capacity of the at least two power supplies is increased.

Another object of the present invention is to provide an electronic device. The electronic device includes at least one power supply, and at least one of a light-emitting diode lamp, a blue tooth loudspeaker, a wireless charger, a solar charger and a storage box. The at least one power supply includes a base body, at least one battery, at least one magnetic component, a conductive element, and a conductive connector electrically connected with the at least one battery. The base body includes a hollow outer shell. A middle of the outer shell has an accommodating space inside the outer shell. The at least one battery is accommodated in the accommodating space. A top of the outer shell has a first buckling surface recessed towards the inside of the outer shell. A bottom of the outer shell has a second buckling surface protruded outward away from the inside of the outer shell and opposite to the first buckling surface. The at least one magnetic component is disposed to the outer shell of the base body. The first buckling surface and the second buckling surface of at least two power supplies cooperate to be combined and fastened by virtue of at least two magnetic components of the at least two power supplies magnetically attracting. The conductive element is of a dual-concentric-ring shape. The conductive element is disposed to and exposed to the first buckling surface, and the conductive element is electrically connected with the at least one battery. The conductive connector is disposed to the second buckling surface, and a bottom of the conductive connector is exposed to the second buckling surface. The bottom of the conductive connector cooperates with and is electrically connected with the conductive element to make the at least two power supplies be electrically connected, so an electric capacity of the at least two power supplies is increased. Each of the at least one of the light-emitting diode lamp, the blue tooth loudspeaker, the wireless charger, the solar charger and the storage box includes the base body which is of an approximately square shape and matched with the base body of the at least one power supply, the first buckling surface disposed to a top of the base body and matched with the second buckling surface of the at least one power supply, the conductive element disposed to and exposed to the first buckling surface, the second buckling surface disposed to a bottom of the base body and matched with the first buckling surface of the at least one power supply, the conductive terminal assembly disposed to and projecting beyond the second buckling surface, and at least one magnetic component disposed to the base body. The at least one magnetic component of the at least one power supply cooperates with and is combined with the at least one magnetic component of one of the light-emitting diode lamp, the blue tooth loudspeaker, the wireless charger, the solar charger and the storage box which have different functions along an up-down direction, more than two of the light-emitting diode lamp, the blue tooth loudspeaker, the wireless charger, the solar charger and the storage box are electrically connected with the at least one power supply by virtue of the conductive elements and the conductive terminal assemblies of the electronic device being electrically connected.

As described above, the at least two power supplies are combined by virtue of the first buckling surface and the second buckling surface of the at least two power supplies cooperating and being combined, the first buckling surface and the second buckling surface of the at least two power supplies cooperate to be further combined and fastened by virtue of the at least two magnetic components of the at least two power supplies magnetically attracting, so that the conductive element and the conductive terminal assembly of the at least two power supplies are connected all the time. Thus the at least two power supplies are electrically connected, and the electric capacity of the electronic device which includes the at least two power supplies is increased. Furthermore, the power supply is capable of being expanded to the different electronic devices with multiple functions, each electronic device has at least one of the light-emitting diode illumination function, the blue tooth loudspeaker function, the wireless charging function, the solar charging function, the storage function and other functions. As a result, the power supply and the electronic device satisfy requirements of different users who use the power supply and the electronic device.

### BRIEF DESCRIPTION OF THE DRAWINGS

The present invention will be apparent to those skilled in the art by reading the following description, with reference to the attached drawings, in which:

FIG. 1 is a perspective view of a power supply in accordance with the present invention;

FIG. 2 is another perspective view of the power supply of FIG. 1;

FIG. 3 is a partially exploded view of the power supply of FIG. 1;

FIG. 4 is a diagrammatic drawing showing an electronic device in accordance with a first preferred embodiment of the present invention, wherein the electronic device includes two power supplies combined with each other;

FIG. 5 is an exploded diagrammatic drawing showing the two power supplies of the electronic device of FIG. 4, wherein the two power supplies are capable of being combined with each other;

FIG. 6 is another exploded diagrammatic drawing showing the two power supplies of the electronic device of FIG. 4, wherein the two power supplies are capable of being combined with each other;

FIG. 7 is a diagrammatic drawing showing the electronic device in accordance with a second preferred embodiment of the present invention, wherein the electronic device includes a light-emitting diode lamp and at least one power supply of FIG. 1;

FIG. 8 is a diagrammatic drawing showing the electronic device in accordance with the second preferred embodiment of the present invention, wherein the electronic device includes a blue tooth loudspeaker and the at least one power supply of FIG. 1;

FIG. 9 is a diagrammatic drawing showing the electronic device in accordance with the second preferred embodiment of the present invention, wherein the electronic device includes a wireless charger and the at least one power supply of FIG. 1;

FIG. 10 is a diagrammatic drawing showing the electronic device in accordance with the second preferred embodiment of the present invention, wherein the electronic device includes a solar charger and the at least one power supply of FIG. 1;

FIG. 11 is a diagrammatic drawing showing the electronic device in accordance with the second preferred embodiment of the present invention, wherein the electronic device includes a storage box and the at least one power supply of FIG. 1; and

FIG. 12 is a diagrammatic drawing showing the electronic device in accordance with the second preferred embodiment of the present invention, wherein the electronic device has multiple functions and includes the light-emitting diode lamp, the blue tooth loudspeaker, the wireless charger, the solar charger, the storage box and the at least one power supply of FIG. 1.

### DETAILED DESCRIPTION OF THE PREFERRED EMBODIMENT

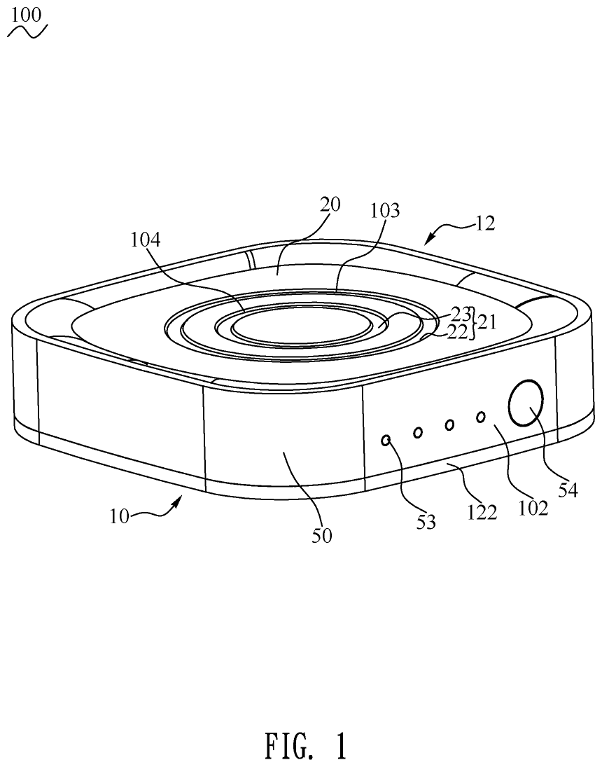

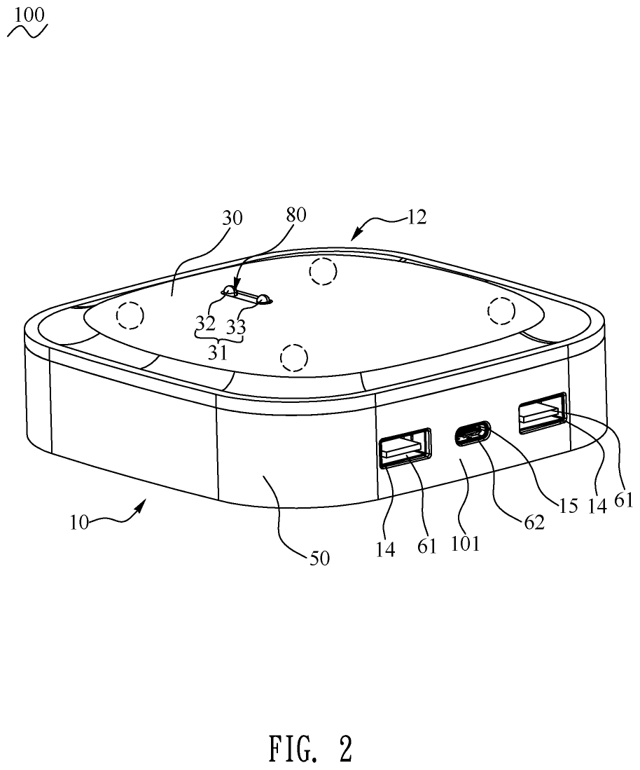

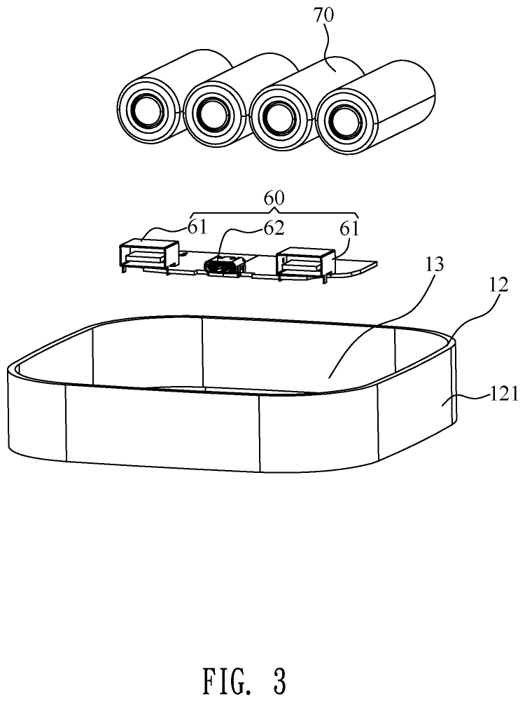

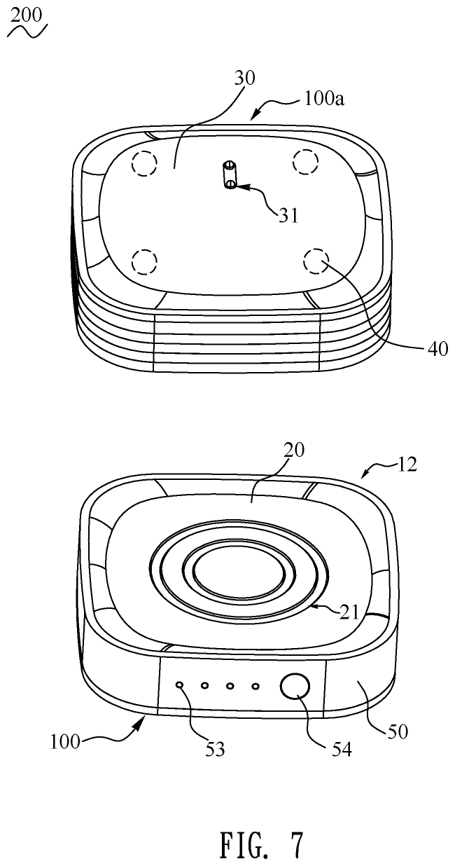

With reference to FIG. 1 to FIG. 7, a power supply 100 and an electronic device 200 in accordance with the present invention are shown. The power supply 100 is capable of being expanded to and applied in the electronic device 200. The power supply 100 includes a base body 10, a first buckling surface 20, a second buckling surface 30, a conductive element 21, a plurality of electrical connectors 60, at least one magnetic component 40, at least one battery 70 and a conductive connector 80. The plurality of the electrical connectors 60 include two output connectors 61 and an input connector 62.

Referring to FIG. 1 to FIG. 6, the base body 10 includes a hollow outer shell 12. The outer shell 12 has a hollow base shell 121 and a bottom cover 122. A middle of the outer shell 12 has an accommodating space 13 inside the outer shell 12 and penetrating through a bottom of the outer shell 12. A bottom of the hollow base shell 121 is opened freely to form the accommodating space 13. The bottom cover 122 is covered to the base shell 121, so the accommodating space 13 is formed between the bottom cover 122 and the base shell 121. The at least one battery 70 is accommodated in the accommodating space 13. A top of the outer shell 12 has the first buckling surface 20 recessed towards the inside of the outer shell 12. The bottom of the outer shell 12 has the second buckling surface 30 protruded outward away from the inside of the outer shell 12 and opposite to the first buckling surface 20. The outer shell 12 has a peripheral surface 50 connected between a periphery of the first buckling surface 20 and a periphery of the second buckling surface 30. The first buckling surface 20 is matched with and combined with the second buckling surface 30.

The outer shell 12 is of an approximately square shape. The base body 10 is of the approximately square shape. Four corners of the base body 10 are of arc shapes seen from a top view. Four corners of the outer shell 12 are of the arc shapes seen from the top view. Four corners of the first buckling surface 20 are of the arc shapes. Four corners of the second buckling surface 30 are of the arc shapes. The power supply 100 includes four batteries 70. The outer shell 12 has a first side surface 101 disposed vertically, and a second side surface 102 disposed vertically and opposite to the first side surface 101. The first side surface 101 of the peripheral surface 50 opens two first openings 14, and a second opening 15 located between the two first openings 14. The plurality of the electrical connectors 60 are electrically connected with the at least one battery 70. The plurality of the electrical connectors 60 are assembled in the accommodating space 13 of the outer shell 12. The two output connectors 61 are corresponding to and exposed to the two first openings 14. The input connector 62 is corresponding to and exposed to the second opening 15. The second side surface 102 of the peripheral surface 50 opposite to the first side surface 101 of the peripheral surface 50 is equipped with a plurality of display lamps 53 and a switch button 54.

The second side surface 102 of the peripheral surface 50 opposite to the first side surface 101 of the peripheral surface 50 is equipped with a plurality of display lamps 53. The second side surface 102 of the peripheral surface 50 opposite to the first side surface 101 of the peripheral surface 50 is equipped with four display lamps 53. The four display lamps 53 are displayed to the second side surface 102 for displaying electric capacities. The switch button 54 is exposed to the second side surface 102 and is capable of being pressed inward or returning to an original position to switch on or switch off the power supply 100. Each battery 70 is a 18650 type lithium battery. A remaining electric capacity of the at least one battery 70 is displayed through the four display lamps 53. Electric capacities of the power supply 100 are transmitted to an electronic product (not shown) by virtue of a first transmission cable (not shown) connected between one output connector 61 of the power supply 100 and the electronic product. The at least one battery 70 of the power supply 100 is charged by virtue of a second transmission cable being connected between the input connector 62 and an outer power source (not shown). The switch button 54 is connected with the at least one battery 70 to control switching on or switching off the power supply 100, and make the plurality of the display lamps 53 shine for displaying the remaining capacity of the at least one battery 70.

Referring to FIG. 1 to FIG. 6 again, the first buckling surface 20 is equipped with a conductive element 21. The conductive element 21 is of a dual-concentric-ring shape. The conductive element 21 is disposed to and exposed to the first buckling surface 20, and the conductive element 21 is electrically connected with the at least one battery 70. The conductive element 21 includes a first conductive slice 22 and a second conductive slice 23. The first conductive slice 22 is of a circular ring shape. The second conductive slice 23 is of a circular ring shape. A diameter of an inner periphery of the first conductive slice 22 is larger than a diameter of an outer periphery of the second conductive slice 23. The first conductive slice 22 and the second conductive slice 23 are disposed on a middle of a top of the base body 10. A middle of a top of the first buckling surface 20 has a ring-shaped first fixing slot 103 recessed downward and matched with the first conductive slice 22, and a ring-shaped second fixing slot 104 recessed downward and matched with the second conductive slice 23. The first fixing slot 103 surrounds and is spaced from an outer periphery of the second fixing slot 104. The ring-shaped first fixing slot 103 and the ring-shaped second fixing slot 104 are concentric.

The first conductive slice 22 is fixed in the first fixing slot 103. The second conductive slice 23 is fixed in the second fixing slot 104. The first conductive slice 22 surrounds and is spaced from an outer periphery of the second conductive slice 23. The first conductive slice 22 of the circular ring shape and the second conductive slice 23 of the circular ring shape are concentric. The first conductive slice 22 and the second conductive slice 23 are disposed on the middle of the top of the first buckling surface 20. The first conductive slice 22 and the second conductive slice 23 of the conductive element 21 are electrically connected with the at least one battery 70. The first conductive slice 22 of the circular ring shape and the second conductive slice 23 of the circular ring shape are electrically connected with the at least one battery 70 through an electrical connection element (not shown). The second buckling surface 30 is equipped with the conductive connector 80 electrically connected with the at least one battery 70. The conductive connector 80 is disposed to the second buckling surface 30, and a bottom of the conductive connector 80 is exposed to the second buckling surface 30. The bottom of the conductive connector 80 cooperates with and is electrically connected with the conductive element 21 to make the at least two power supplies 100 be electrically connected, so an electric capacity of the at least two power supplies 100 is increased. The conductive connector 80 is a probe connector. The conductive connector 80 includes a conductive terminal assembly 31 disposed to and projecting beyond the second buckling surface 30. The conductive terminal assembly 31 includes a first conductive terminal 32 projecting beyond the second buckling surface 30, and a second conductive terminal 33 projecting beyond the second buckling surface 30.

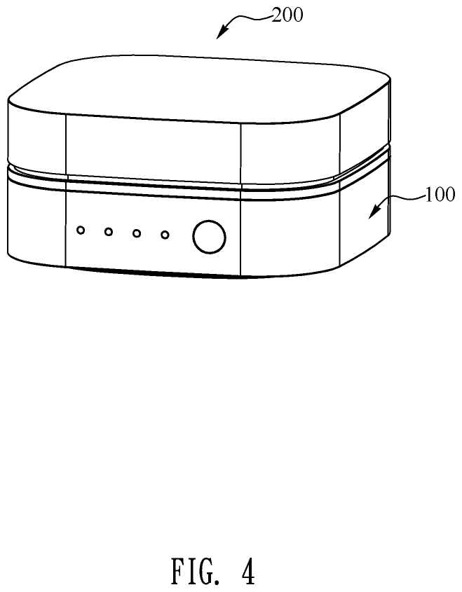

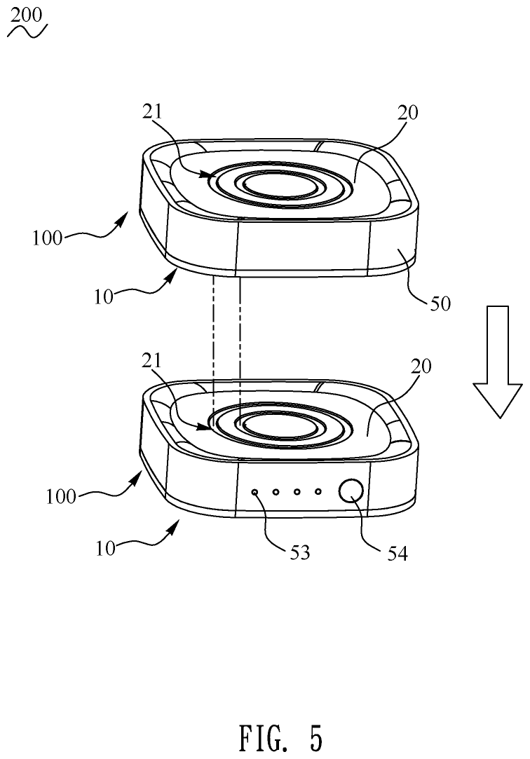

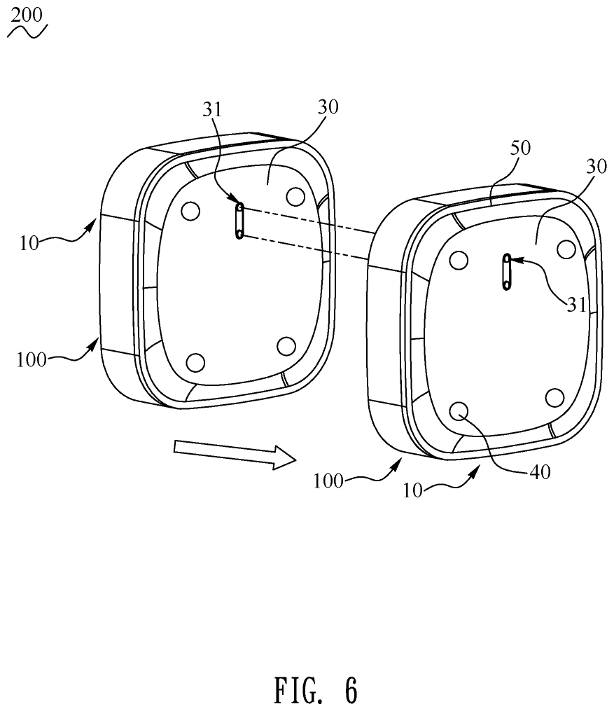

The electronic device 200 in accordance with a first preferred embodiment of the present invention, includes at least two power supplies 100 combined together and stacked in an up-down direction to have a durable battery life. In the first preferred embodiment, the electronic device 200 shown in FIG. 4, FIG. 5 and FIG. 6, includes two power supplies 100. When the at least two power supplies 100 are stacked in the up-down direction, the first conductive slice 22 of the first buckling surface 20 of one power supply 100 and the first conductive terminal 32 of the second buckling surface 30 of another power supply 100 mounted on the one power supply 100 are electrically connected with each other, and the second conductive slice 23 of the first buckling surface 20 of the one power supply 100 and the second conductive terminal 33 of the second buckling surface 30 of another power supply 100 mounted on the one power supply 100 are electrically connected with each other.

The first buckling surface 20 of the one power supply 100 is matched with and combined with the second buckling surface 30 of another power supply 100 which is mounted on the one power supply 100 in different angles by virtue of a modular structure design of the conductive element 21 and the conductive terminal assembly 31 of the two power supplies 100, so that the at least two power supplies 100 are capable of achieving the electrical connection effect and the electric capacity increasing effect. In the first preferred embodiment, the first buckling surface 20 of the one power supply 100 is matched with and combined with the second buckling surface 30 of another power supply 100 which is mounted on the one power supply 100 in different angles by virtue of the base body 10 being of the approximately square shape, and the first conductive slice 22 and the second conductive slice 23 being disposed on the middle of the top of the base body 10 and being of ring shapes to be electrically connected with the first conductive terminal 32 and the second conductive terminal 33 in different directions.

Referring to FIG. 1 to FIG. 6 again, the at least two power supplies 100 are combined by virtue of the first buckling surface 20 and the second buckling surface 30 of the at least two power supplies 100 cooperating and being combined. In order to make the at least two power supplies 100 facilitate being combined along the up-down direction for achieving the electrical connection effect and the electric capacity increasing effect. The at least two power supplies 100 are stacked along the up-down direction by virtue of the first buckling surface 20 and the second buckling surface 30 of the outer shells 12 of each two adjacent power supplies 100 being buckled with each other, so that the electrical connection effect of the at least two power supplies 100 is achieved. In order to further improve a convenience of a user, the first buckling surface 20 and the second buckling surface 30 of the power supply 100 adopt directionless designs by virtue of the base body 10 being of the approximately square shape, and the first conductive slice 22 and the second conductive slice 23 being disposed on the middle of the top of the base body 10 and being of the ring shapes to be electrically connected with the first conductive terminal 32 and the second conductive terminal 33 in the different directions, when the at least two power supplies 100 are stacked along the up-down direction and by the user, the first buckling surface 20 and the second buckling surface 30 of the outer shells 12 of each two adjacent power supplies 100 are buckled with each other without need of choosing stacking directions.

Referring to FIG. 1 to FIG. 6, when the at least two power supplies 100 are stacked along the up-down direction to form the electronic device 200, in order to prevent at least one power supply 100 breaking away from the electronic device 200, the outer shell 12 is equipped with the at least one magnetic component 40. The at least one magnetic component 40 is disposed to the outer shell 12 of the base body 10, and is disposed to at least one of the first buckling surface 20 and the second buckling surface 30. The at least one magnetic component 40 of the at least one of the first buckling surface 20 and the second buckling surface 30 is disposed around an inside of a periphery of the at least one of the first buckling surface 20 and the second buckling surface 30. The at least one magnetic component 40 is at least one magnet.

In the first preferred embodiment, when the two power supplies 100 are combined along the up-down direction, one of the two power supplies 100 includes four magnetic components 40 disposed to the first buckling surface 20 and inside a periphery of the first buckling surface 20. The four magnetic components 40 of the first buckling surface 20 are adjacent to and spaced from inner sides of four corners of the first buckling surface 20. The other power supply 100 includes four magnetic components 40 disposed to the second buckling surface 30 and inside a periphery of the second buckling surface 30. The four magnetic components 40 of the second buckling surface 30 are adjacent to and spaced from inner sides of four corners of the second buckling surface 30. The four magnetic components 40 of the first buckling surface 20 and the four magnetic components 40 of the second buckling surface 30 are attracted. When the first buckling surface 20 and the second buckling surface 30 of the at least two power supplies 100 approach and are corresponding to each other along the up-down direction, the first buckling surface 20 and the second buckling surface 30 of the at least two power supplies 100 cooperate to be combined and fastened by virtue of at least two magnetic components 40 of the at least two power supplies 100 magnetically attracting, so that the conductive element 21 and the conductive terminal assembly 31 of the at least two power supplies 100 are connected all the time. Peripheral surfaces 50 of the at least two power supplies 100 are aligned. Thus the at least two power supplies 100 are electrically connected, and an electric capacity of the electronic device 200 which includes the at least two power supplies 100 is increased.

Referring to FIG. 1 to FIG. 5, when the at least two power supplies 100 approach and are stacked along the up-down direction, the at least one power supply 100 is prevented breaking away from the electronic device 200 accidentally by virtue of the at least two magnetic components 40 of the at least two power supplies 100 magnetically attracting.

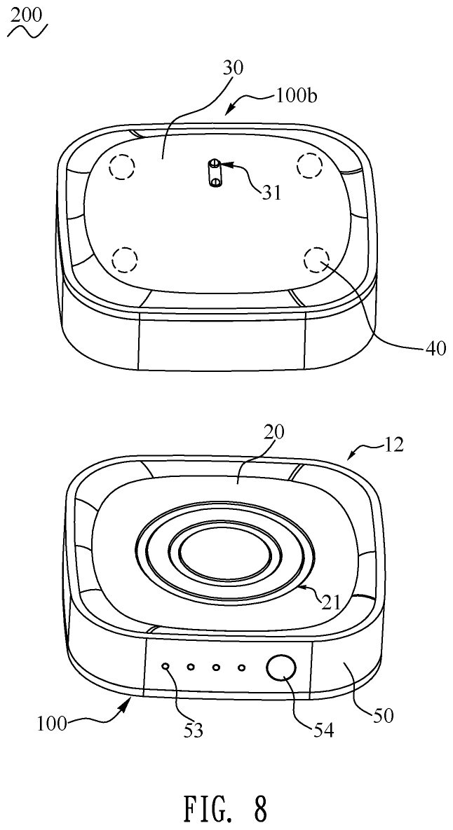

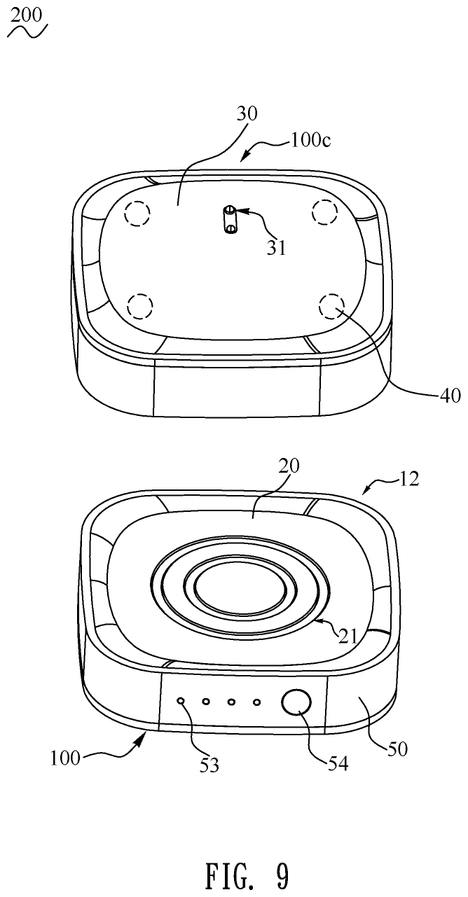

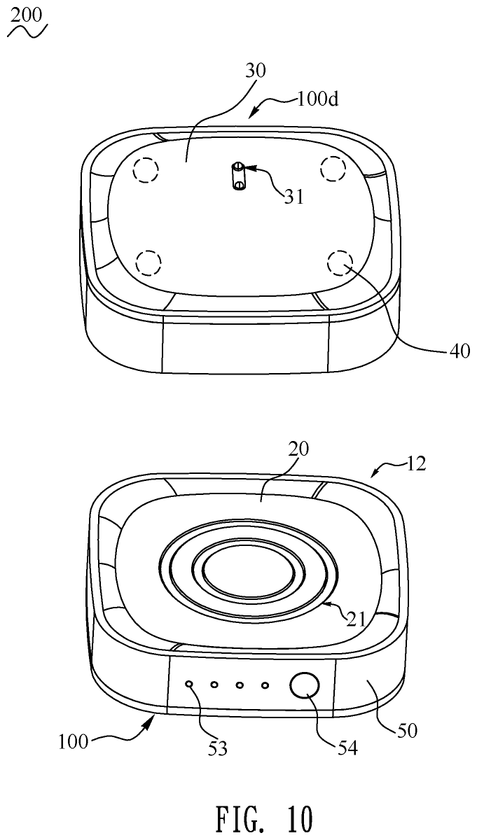

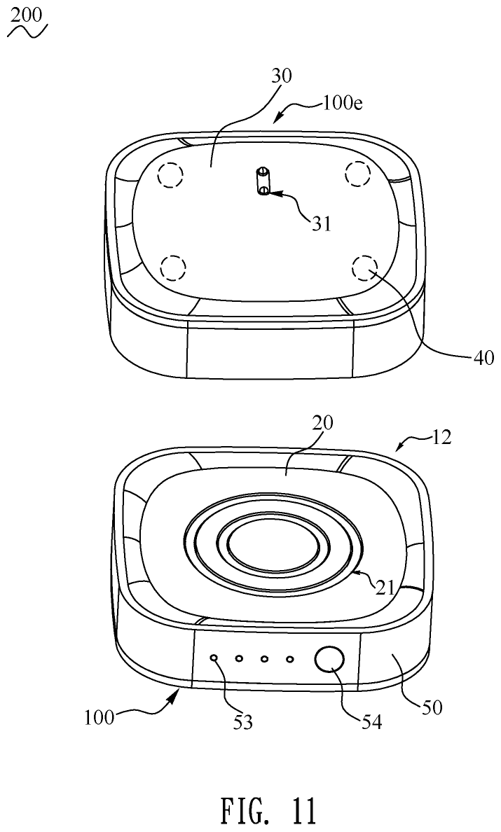

Referring to FIG. 1 to FIG. 12, the power supply 100 is capable of being expanded to a light-emitting diode (LED) lamp 100a, a blue tooth loudspeaker 100b, a wireless charger 100c, a solar charger 100d and a storage box 100e. The electronic device 200 in accordance with a second preferred embodiment of the present invention is shown. The power supply 100 is capable of being expanded to and applied in different electronic devices 200 with multiple functions. Each electronic device 200 has at least one of a light-emitting diode (LED) illumination function, a blue tooth loudspeaker function, a wireless charging function, a solar charging function, a storage function and other functions. Each electronic device 200 includes the at least one power supply 100, and at least one of the light-emitting diode (LED) lamp 100a, the blue tooth loudspeaker 100b, the wireless charger 100c, the solar charger 100d and the storage box 100e. The electronic device 200 which has the light-emitting diode (LED) illumination function, includes a light-emitting diode (LED) lamp 100a and at least one power supply 100. The electronic device 200 which has the blue tooth loudspeaker function, includes a blue tooth loudspeaker 100b and the at least one power supply 100. The electronic device 200 which has the wireless charging function, includes a wireless charger 100c and the at least one power supply 100. The electronic device 200 which has the solar charging function, includes a solar charger 100d and the at least one power supply 100. The electronic device 200 which has the storage function, includes a storage box 100e and the at least one power supply 100.

Each of the light-emitting diode (LED) lamp 100a, the blue tooth loudspeaker 100b, the wireless charger 100c, the solar charger 100d and the storage box 100e includes the base body 10 of the approximately square shape and matched with the base body 10 of the at least one power supply 100, the second buckling surface 30 disposed to a bottom of the base body 10 and matched with the first buckling surface 20 of the at least one power supply 100, and the conductive terminal assembly 31 disposed to and projecting beyond the second buckling surface 30. Specifically, the light-emitting diode (LED) lamp 100a includes the base body 10 which is of the approximately square shape and matched with the base body 10 of the at least one power supply 100, the second buckling surface 30 matched with the first buckling surface 20 of the at least one power supply 100, and the conductive terminal assembly 31. The blue tooth loudspeaker 100b includes the base body 10 of the approximately square shape, the second buckling surface 30 and the conductive terminal assembly 31. The wireless charger 100c includes the base body 10 of the approximately square shape, the second buckling surface 30 and the conductive terminal assembly 31. The solar charger 100d includes the base body 10 of the approximately square shape, the second buckling surface 30 and the conductive terminal assembly 31. The storage box 100e includes the base body 10 of the approximately square shape, the second buckling surface 30 and the conductive terminal assembly 31. The different electronic devices 200 with different functions are further expanded on account of modular structure designs of the conductive elements 21 and the conductive terminal assemblies 31 of the different electronic devices 200.

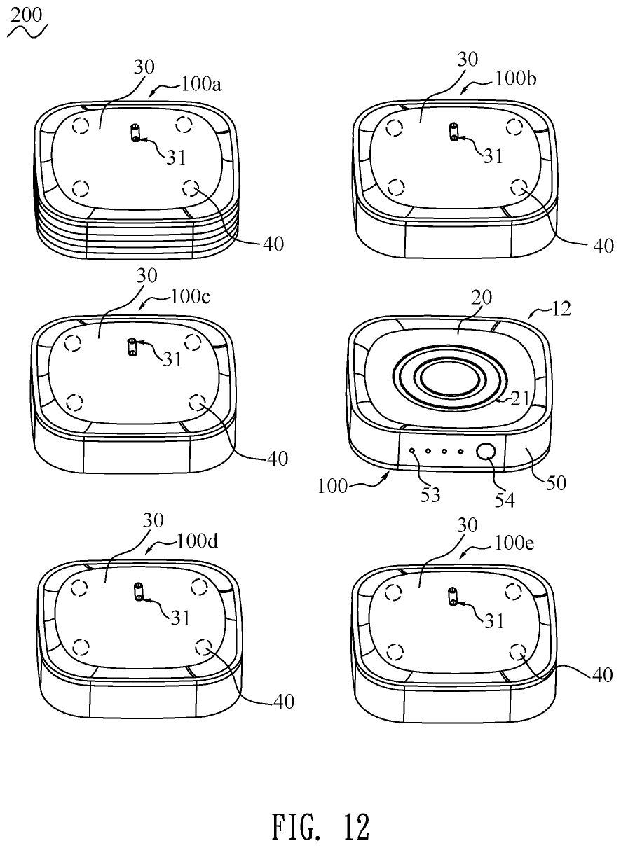

In the second preferred embodiment, at least one electronic device 200 is capable of having more than two functions which include the light-emitting diode (LED) illumination function, the blue tooth loudspeaker function, the wireless charging function, the solar charging function and the storage function, so the at least one electronic device 200 includes more than two of the light-emitting diode (LED) lamp 100a, the blue tooth loudspeaker 100b, the wireless charger 100c, the solar charger 100d and the storage box 100e, and the at least one power supply 100. Each of the light-emitting diode (LED) lamp 100a, the blue tooth loudspeaker 100b, the wireless charger 100c, the solar charger 100d and the storage box 100e further includes the first buckling surface 20 disposed to a top of the base body 10 and matched with the second buckling surface 30 of the at least one power supply 100, and the conductive element 21 disposed to and exposed to the first buckling surface 20. Each electronic device 200 includes at least one of the light-emitting diode (LED) lamp 100a, the blue tooth loudspeaker 100b, the wireless charger 100c, the solar charger 100d and the storage box 100e, and the at least one power supply 100. One electronic device 200 is capable of including the light-emitting diode (LED) lamp 100a, the blue tooth loudspeaker 100b, the wireless charger 100c, the solar charger 100d, the storage box 100e and the at least one power supply 100 to have the multiple functions. The one electronic device 200 shown in FIG. 12, has the multiple functions and includes the light-emitting diode (LED) lamp 100a, the blue tooth loudspeaker 100b, the wireless charger 100c, the solar charger 100d, the storage box 100e and the at least one power supply 100.

In use, when the at least one power supply 100 is applied in electronic device 200 which has the light-emitting diode (LED) illumination function or the blue tooth loudspeaker function, the at least one power supply 100 transmits electrical energies to the light-emitting diode (LED) lamp 100a or the blue tooth loudspeaker 100b by virtue of the conductive terminal assembly 31 of the light-emitting diode (LED) lamp 100a or the blue tooth loudspeaker 100b being electrically connected with the conductive element 21 of the at least one power supply 100, so the electronic device 200 which has the light-emitting diode (LED) illumination function or the blue tooth loudspeaker function are capable of being used in outdoor environments and other environments without power source devices.

When the at least one power supply 100 is applied in the electronic device 200 which has the wireless charging function, the at least one power supply 100 transmits the electrical energies to the wireless charger 100c by virtue of the conductive terminal assembly 31 of the wireless charger 100c being electrically connected with the conductive element 21 of the at least one power supply 100, so a mobile phone (not shown) reaches a charging effect by virtue of the mobile phone being electrically connected with the electronic device 200 which has the wireless charging function.

When the at least one power supply 100 is applied in the electronic device 200 which has the solar charging function, the solar charger 100d charges the at least one power supply 100 by virtue of the conductive terminal assembly 31 of the solar charger 100d being electrically connected with the conductive element 21 of the at least one power supply 100, so the at least one power supply 100 is charged without a connection cable (not shown).

When the at least one power supply 100 is applied in the electronic device 200 which has the storage function, the storage box 100e is electrically connected with the at least one power supply 100 by virtue of the conductive terminal assembly 31 of the solar charger 100d being electrically connected with the conductive element 21 of the at least one power supply 100.

In the second preferred embodiment, when the at least one power supply 100 is applied in the electronic device 200 which has the more than two functions, more than two of the light-emitting diode (LED) lamp 100a, the blue tooth loudspeaker 100b, the wireless charger 100c, the solar charger 100d and the storage box 100e are electrically connected with the at least one power supply 100 by virtue of the conductive elements 21 and the conductive terminal assemblies 31 of the electronic device 200 which has the more than two functions being electrically connected.

In the second preferred embodiment, when the at least one power supply 100 is applied in the electronic device 200 which has the multiple functions, the light-emitting diode (LED) lamp 100a, the blue tooth loudspeaker 100b, the wireless charger 100c, the solar charger 100d and the storage box 100e are electrically connected with the at least one power supply 100 by virtue of the conductive elements 21 and the conductive terminal assemblies 31 of the electronic device 200 which has the multiple functions, being electrically connected.

Each of the light-emitting diode (LED) lamp 100a, the blue tooth loudspeaker 100b, the wireless charger 100c, the solar charger 100d and the storage box 100e, includes the at least one magnetic component 40 disposed to the base body 10. The at least one magnetic component 40 of the at least one power supply 100 cooperates with and is combined with the at least one magnetic component 40 of one of the light-emitting diode (LED) lamp 100a, the blue tooth loudspeaker 100b, the wireless charger 100c, the solar charger 100d and the storage box 100e, which have different functions along the up-down direction, and a modular structure design of the conductive element 21 of the at least one power supply 100 and the conductive terminal assembly 31 of the one of the light-emitting diode (LED) lamp 100a, the blue tooth loudspeaker 100b, the wireless charger 100c, the solar charger 100d and the storage box 100e, the first buckling surface 20 of the at least one power supply 100 approaches and is corresponding to the second buckling surface 30 of the one of the light-emitting diode (LED) lamp 100a, the blue tooth loudspeaker 100b, the wireless charger 100c, the solar charger 100d and the storage box 100e along the up-down direction, and the first buckling surface 20 of the at least one power supply 100 cooperates with the second buckling surface 30 of the one of the light-emitting diode (LED) lamp 100a, the blue tooth loudspeaker 100b, the wireless charger 100c, the solar charger 100d and the storage box 100e to be combined and fastened with each other by virtue of the at least one magnetic component 40 of the at least one power supply 100 being magnetically attracted with the at least one magnetic component 40 of the one of the light-emitting diode (LED) lamp 100a, the blue tooth loudspeaker 100b, the wireless charger 100c, the solar charger 100d and the storage box 100e, so that the conductive element 21 of the at least one power supply 100 is connected with the conductive terminal assembly 31 of the one of the light-emitting diode (LED) lamp 100a, the blue tooth loudspeaker 100b, the wireless charger 100c, the solar charger 100d and the storage box 100e all the time. Peripheral surfaces 50 of the at least one power supply 100, and the one of the light-emitting diode (LED) lamp 100a, the blue tooth loudspeaker 100b, the wireless charger 100c, the solar charger 100d and the storage box 100e are aligned.

As described above, the at least two power supplies 100 are combined by virtue of the first buckling surface 20 and the second buckling surface 30 of the at least two power supplies 100 cooperating and being combined, the first buckling surface 20 and the second buckling surface 30 of the at least two power supplies 100 cooperate to be further combined and fastened by virtue of the at least two magnetic components 40 of the at least two power supplies 100 magnetically attracting, so that the conductive element 21 and the conductive terminal assembly 31 of the at least two power supplies 100 are connected all the time. Thus the at least two power supplies 100 are electrically connected, and the electric capacity of the electronic device 200 which includes the at least two power supplies 100 is increased. Furthermore, the power supply 100 is capable of being expanded to the different electronic devices 200 with the multiple functions, each electronic device 200 has at least one of the light-emitting diode (LED) illumination function, the blue tooth loudspeaker function, the wireless charging function, the solar charging function, the storage function and other functions. As a result, the power supply 100 and the electronic device 200 satisfy requirements of different users who use the power supply 100 and the electronic device 200.

What is claimed is:

1. A power supply, comprising:
a base body including a hollow outer shell, a middle of the outer shell having an accommodating space inside the outer shell, a top of the outer shell having a first buckling surface recessed towards the inside of the outer shell, a bottom of the outer shell having a second buckling surface protruded outward away from the inside of the outer shell and opposite to the first buckling surface;
at least one battery accommodated in the accommodating space;
at least one magnetic component disposed to the outer shell of the base body, the first buckling surface and the second buckling surface of at least two power supplies cooperating to be combined and fastened by virtue of at least two magnetic components of the at least two power supplies magnetically attracting;
a conductive element, the conductive element being of a dual-concentric-ring shape, the conductive element being disposed to and exposed to the first buckling surface, and the conductive element being electrically connected with the at least one battery; and
a conductive connector electrically connected with the at least one battery, the conductive connector being disposed to the second buckling surface, and a bottom of the conductive connector being exposed to the second buckling surface, the bottom of the conductive connector cooperating with and being electrically connected with the conductive element to make the at least two power supplies be electrically connected, so an electric capacity of the at least two power supplies being increased.

2. The power supply as claimed in claim 1, wherein the conductive element includes a first conductive slice of a circular ring shape, and a second conductive slice of a circular ring shape, a middle of a top of the first buckling surface has a ring-shaped first fixing slot recessed downward and matched with the first conductive slice, and a ring-shaped second fixing slot recessed downward and matched with the second conductive slice, the first fixing slot surrounds and is spaced from an outer periphery of the second fixing slot, the ring-shaped first fixing slot and the ring-shaped second fixing slot are concentric, the first conductive slice is fixed in the first fixing slot, the second conductive slice is fixed in the second fixing slot, the first conductive slice surrounds and is spaced from an outer periphery of the second conductive slice, the first conductive slice of the circular ring shape and the second conductive slice of the circular ring shape are concentric, so the first conductive slice and the second conductive slice are disposed on the middle of the top of the first buckling surface, the first conductive slice and the second conductive slice are electrically connected with the at least one battery.

3. The power supply as claimed in claim 2, wherein the conductive connector is a probe connector, the conductive connector includes a conductive terminal assembly, the conductive terminal assembly includes a first conductive terminal projecting beyond the second buckling surface, and a second conductive terminal projecting beyond the second buckling surface, when the at least two power supplies are stacked in an up-down direction, the first conductive slice of the first buckling surface of one power supply and the first conductive terminal of the second buckling surface of another power supply mounted on the one power supply are electrically connected with each other, and the second conductive slice of the first buckling surface of the one power supply and the second conductive terminal of the second buckling surface of another power supply mounted on the one power supply are electrically connected with each other.

4. The power supply as claimed in claim 2, wherein the first conductive slice and the second conductive slice are disposed on a middle of a top of the base body, a diameter of an inner periphery of the first conductive slice is larger than a diameter of an outer periphery of the second conductive slice.

5. The power supply as claimed in claim 1, wherein the at least one magnetic component is disposed around an inside of a periphery of the at least one of the first buckling surface and the second buckling surface.

6. The power supply as claimed in claim 1, wherein when two power supplies are combined along an up-down direction, one of the two power supplies includes four magnetic components disposed to the first buckling surface and inside a periphery of the first buckling surface, the four magnetic components of the first buckling surface are adjacent to and spaced from inner sides of four corners of the first buckling surface, the other power supply includes four magnetic components disposed to the second buckling surface and inside a periphery of the second buckling surface, the four magnetic components of the second buckling surface are adjacent to and spaced from inner sides of four corners of the second buckling surface, the four magnetic components of the first buckling surface and the four magnetic components of the second buckling surface are attracted.

7. The power supply as claimed in claim 1, wherein the power supply is capable of being expanded to and applied in an electronic device, the electronic device includes the at least two power supplies combined together and stacked in an up-down direction to have a durable battery life, peripheral surfaces of the at least two power supplies are aligned.

8. The power supply as claimed in claim 1, wherein the power supply is capable of being expanded to a light-emitting diode lamp, a blue tooth loudspeaker, a wireless charger, a solar charger and a storage box, the power supply is capable of being expanded to and applied in different electronic devices with multiple functions, each electronic device has at least one of a light-emitting diode illumination function, a blue tooth loudspeaker function, a wireless charging function, a solar charging function and a storage function.

9. The power supply as claimed in claim 8, wherein the electronic device which has the light-emitting diode illumination function, includes a light-emitting diode lamp and at least one power supply, the electronic device which has the blue tooth loudspeaker function, includes a blue tooth loudspeaker and the at least one power supply, the electronic device which has the wireless charging function, includes a wireless charger and the at least one power supply, the electronic device which has the solar charging function, includes a solar charger and the at least one power supply, the electronic device which has the storage function, includes a storage box and the at least one power supply.

10. The power supply as claimed in claim 9, wherein each of the light-emitting diode lamp, the blue tooth loudspeaker, the wireless charger, the solar charger and the storage box, includes the at least one magnetic component, the at least one magnetic component of the at least one power supply cooperates with and is combined with the at least one magnetic component of one of the light-emitting diode lamp, the blue tooth loudspeaker, the wireless charger, the solar charger and the storage box which have different functions along an up-down direction.

11. The power supply as claimed in claim 10, wherein each of the light-emitting diode lamp, the blue tooth loudspeaker, the wireless charger, the solar charger and the storage box includes the base body of an approximately square shape, the second buckling surface and the conductive terminal assembly, the first buckling surface of the at least one power supply cooperates with the second buckling surface of the one of the light-emitting diode lamp, the blue tooth loudspeaker, the wireless charger, the solar charger and the storage box to be combined and fastened with each other by virtue of the at least one magnetic component of the at least one power supply being magnetically attracted with the at least one magnetic component of the one of the light-emitting diode lamp, the blue tooth loudspeaker, the wireless charger, the solar charger and the storage box, so that the conductive element of the at least one power supply is connected with the conductive terminal assembly of the one of the light-emitting diode lamp, the blue tooth loudspeaker, the wireless charger, the solar charger and the storage box all the time.

12. The power supply as claimed in claim 11, wherein at least one electronic device is capable of having more than two functions which include the light-emitting diode illumination function, the blue tooth loudspeaker function, the wireless charging function, the solar charging function and the storage function, so the at least one electronic device includes more than two of the light-emitting diode lamp, the blue tooth loudspeaker, the wireless charger, the solar charger and the storage box, and the at least one power supply.

13. The power supply as claimed in claim 12, wherein each of the light-emitting diode lamp, the blue tooth loudspeaker, the wireless charger, the solar charger and the storage box further includes the first buckling surface and the conductive element, more than two of the light-emitting diode lamp, the blue tooth loudspeaker, the wireless charger, the solar charger and the storage box are electrically connected with the at least one power supply by virtue of the conductive elements and the conductive terminal assemblies of the electronic device which has the more than two functions being electrically connected.

14. The power supply as claimed in claim 10, wherein one electronic device is capable of including the light-emitting diode lamp, the blue tooth loudspeaker, the wireless charger, the solar charger, the storage box and the at least one power supply to have the multiple functions.

15. An electronic device, comprising:
at least two power supplies, each power supply including:
a base body including a hollow outer shell, a middle of the outer shell having an accommodating space inside the outer shell, a top of the outer shell having a first buckling surface recessed towards the inside of the outer shell, a bottom of the outer shell having a second buckling surface protruded outward away from the inside of the outer shell and opposite to the first buckling surface;
at least one battery accommodated in the accommodating space;
at least one magnetic component disposed to the outer shell of the base body, the first buckling surface and the second buckling surface of the at least two power supplies cooperating to be combined and fastened by virtue of at least two magnetic components of the at least two power supplies magnetically attracting,
a conductive element, the conductive element being of a dual-concentric-ring shape, the conductive element being disposed to and exposed to the first buckling surface, and the conductive element being electrically connected with the at least one battery; and
a conductive connector electrically connected with the at least one battery, the conductive connector being disposed to the second buckling surface, and a bottom of the conductive connector being exposed to the second buckling surface, the bottom of the conductive connector cooperating with and being electrically connected with the conductive element to make the at least two power supplies be electrically connected, so an electric capacity of the at least two power supplies being increased.

16. The electronic device as claimed in claim 15, wherein the conductive element includes a first conductive slice of a circular ring shape, and a second conductive slice of a circular ring shape, a middle of a top of the first buckling surface has a ring-shaped first fixing slot recessed downward and matched with the first conductive slice, and a ring-shaped second fixing slot recessed downward and matched with the second conductive slice, the first fixing slot surrounds and is spaced from an outer periphery of the second fixing slot, the ring-shaped first fixing slot and the ring-shaped second fixing slot are concentric, the first conductive slice is fixed in the first fixing slot, the second conductive slice is fixed in the second fixing slot, the first conductive slice surrounds and is spaced from an outer periphery of the second conductive slice, the first conductive slice of the circular ring shape and the second conductive slice of the circular ring shape are concentric, so the first conductive slice and the second conductive slice are disposed on the middle of the top of the first buckling surface, the first conductive slice and the second conductive slice are electrically connected with the at least one battery.

17. The electronic device as claimed in claim 16, wherein the conductive connector is a probe connector, the conductive connector includes a conductive terminal assembly, the conductive terminal assembly includes a first conductive terminal projecting beyond the second buckling surface, and a second conductive terminal projecting beyond the second buckling surface, when the at least two power supplies are stacked in an up-down direction, the first conductive slice of the first buckling surface of one power supply and the first conductive terminal of the second buckling surface of another power supply mounted on the one power supply are electrically connected with each other, and the second conductive slice of the first buckling surface of the one power supply and the second conductive terminal of the second buckling surface of another power supply mounted on the one power supply are electrically connected with each other.

18. An electronic device, comprising:
at least one power supply including:
a base body including a hollow outer shell, a middle of the outer shell having an accommodating space inside the outer shell, a top of the outer shell having a first buckling surface recessed towards the inside of the outer shell, a bottom of the outer shell having a second buckling surface protruded outward away from the inside of the outer shell and opposite to the first buckling surface;
at least one battery accommodated in the accommodating space;
at least one magnetic component disposed to the outer shell of the base body, the first buckling surface and the second buckling surface of at least two power supplies cooperating to be combined and fastened by virtue of at least two magnetic components of the at least two power supplies magnetically attracting;
a conductive element, the conductive element being of a dual-concentric-ring shape, the conductive element being disposed to and exposed to the first buckling surface, and the conductive element being electrically connected with the at least one battery; and
a conductive connector electrically connected with the at least one battery, the conductive connector being disposed to the second buckling surface, and a bottom of the conductive connector being exposed to the second buckling surface, the bottom of the conductive connector cooperating with and being electrically connected with the conductive element to make the at least two power supplies be electrically connected, so an electric capacity of the at least two power supplies being increased; and
at least one of a light-emitting diode lamp, a blue tooth loudspeaker, a wireless charger, a solar charger and a storage box, each of the light-emitting diode lamp, the blue tooth loudspeaker, the wireless charger, the solar charger and the storage box including the base body which is of an approximately square shape and matched with the base body of the at least one power supply, the first buckling surface disposed to a top of the base body and matched with the second buckling surface of the at least one power supply, the conductive element disposed to and exposed to the first buckling surface, the second buckling surface disposed to a bottom of the base body and matched with the first buckling surface of the at least one power supply, the conductive terminal assembly disposed to and projecting beyond the second buckling surface, and at least one magnetic component disposed to the base body;
wherein the at least one magnetic component of the at least one power supply cooperates with and is combined with the at least one magnetic component of one of the light-emitting diode lamp, the blue tooth loudspeaker, the wireless charger, the solar charger and the storage box which have different functions along an up-down direction, more than two of the light-emitting diode lamp, the blue tooth loudspeaker, the wireless charger, the solar charger and the storage box are electrically connected with the at least one power supply by virtue of the conductive elements and the conductive terminal assemblies of the electronic device being electrically connected.

19. The electronic device as claimed in claim 18, wherein the conductive element includes a first conductive slice of a circular ring shape, and a second conductive slice of a circular ring shape, a middle of a top of the first buckling surface has a ring-shaped first fixing slot recessed downward and matched with the first conductive slice, and a ring-shaped second fixing slot recessed downward and matched with the second conductive slice, the first fixing slot surrounds and is spaced from an outer periphery of the second fixing slot, the ring-shaped first fixing slot and the ring-shaped second fixing slot are concentric, the first conductive slice is fixed in the first fixing slot, the second conductive slice is fixed in the second fixing slot, the first conductive slice surrounds and is spaced from an outer periphery of the second conductive slice, the first conductive slice of the circular ring shape and the second conductive slice of the circular ring shape are concentric, so the first conductive slice and the second conductive slice are disposed on the middle of the top of the first buckling surface, the first conductive slice and the second conductive slice are electrically connected with the at least one battery.

20. The electronic device as claimed in claim 19, wherein the conductive connector is a probe connector, the conductive connector includes a conductive terminal assembly, the conductive terminal assembly includes a first conductive terminal projecting beyond the second buckling surface, and a second conductive terminal projecting beyond the second buckling surface, when the at least two power supplies are stacked in an up-down direction, the first conductive slice of the first buckling surface of one power supply and the first conductive terminal of the second buckling surface of another power supply mounted on the one power supply are electrically connected with each other, and the second conductive slice of the first buckling surface of the one power supply and the second conductive terminal of the second buckling surface of another power supply mounted on the one power supply are electrically connected with each other.
